(19) United States
(12) Patent Application Publication
(10) Pub. No.: US 2012/0026047 A1
(43) Pub. Date: Feb. 2, 2012

(54) MONOPOLE ANTENNA, ANTENNA ASSEMBLY, AND VEHICLE

(75) Inventor: Fabien Ferrero, Sophia Antipolis Cedex (FR)

(73) Assignee: AISIN SEIKI KABUSHIKI KAISHA, Kariya-shi, Aichi-ken (JP)

(21) Appl. No.: 13/257,242

(22) PCT Filed: Mar. 18, 2010
(86) PCT No.: PCT/JP2010/054705

§ 371 Date: Oct. 12, 2011

(30) Foreign Application Priority Data
Apr. 15, 2009 (FR) 0952472

(51) Int. Cl. H01Q 1/32; H01Q 9/04

(52) U.S. Cl. 343/711; 343/700 MS

(57) ABSTRACT

A monopole antenna (14A) has an ultra wide band and is configured to be capable of receiving/sending at least a frequency modulation signal in an FM band which is a predetermined frequency band of which the reflection coefficient (S11) is less than −6 dB. If the monopole antenna (14A) is an ultra wide band type one, the monopole antenna (14A) can be used for various purposes such as cellular phones, Wi-Fi, TV, DAB (Digital Audio Broadcast), or the like. Also provided is an antenna assembly consisting of an element formed of a plastic material for vehicle and the monopole antenna (14A) attached to the element of plastic material. The antenna assembly only has to comprise at least one monopole antenna and may comprise two or three monopole antennas (14A). Further, provided is a vehicle including at least one above-described monopole antenna (14A) or the above-described antenna assembly.

### TECHNICAL FIELD

The present invention relates to the field of antennas.

The present invention particularly relates to antennas used in the field of automobiles.

### BACKGROUND ART

Antennas for automobiles called radio antennas are known. Although the efficiency for this type of antenna is favorable (70% or more), its appearance is comparatively poor. Furthermore, this antenna is easily susceptible to malicious damage, has the possibility of producing noise when traveling at high speeds, and only performs well in a limited bandwidth within the range of 87 to 108 MHz corresponding to radio frequency.

Meanwhile, the electromagnetic spectrum includes a plurality of frequency bands dedicated to various applications. In Europe, for example, the band from 88 to 108 MHz is dedicated to radio, while the band from 470 to 862 MHz is dedicated to television.

In the future, it will become possible to use many applications (such as TV, Wi-Fi, and mobile phones) inside an automobile. However, although a radio antenna like that described in Patent Literature 1 has good performance in a frequency range limited to the FM band, its performance suffers in other frequency ranges, and thus its performance is insufficient as an antenna for other applications inside an automobile.

### PRIOR ART DOCUMENTS

Patent Literature 1: Unexamined Japanese Patent Application KOKAI Publication No. H4-260883

### DISCLOSURE OF INVENTION

### Problem to be Solved by the Invention

It is an object of the present invention to provide an antenna that makes many applications usable inside a vehicle.

### Means for Solving the Problem

For this purpose, the present invention takes as an object to provide a monopole antenna having an ultra wide band, and configured to be able to receive and/or transmit at least a frequency-modulated signal in an FM band, which is a predetermined frequency band where the reflection coefficient is less than −6 dB.

An ultra wide band antenna is defined to be an antenna having a band whose bandwidth is greater than a minimum value among values equal to 20% of the center frequency of the band, or greater than 500 MHz.

In order to measure antenna performance, a parameter called S11 is used. The parameter S11 indicates an antenna's reflection coefficient. In the case where S11=0 dB, all power is reflected by the antenna, and no power is emitted from the antenna. In the case where S11=−10 dB, 90% of the power is emitted from the antenna, and 10% of the power is reflected. For this reason, in order to improve antenna performance in a given frequency band, it is desirable to decrease the algebraic value of the parameter S11 as much as possible and increase its absolute value as much as possible. Consequently, an antenna having a parameter of S11=−40 dB for a given frequency has better performance than an antenna having S11=−10 dB at the same frequency. In the case where an antenna has a parameter S11 that is nearly less than a performance threshold value in a given frequency range or equal to this performance threshold value, performance is seen as good for the given frequency range. In this case, the parameter S11 has a frequency band corresponding to that frequency range. Typically, the performance threshold value is −6 dB.

In the case where a monopole antenna is of the ultra wide band type, it is possible to use the antenna for various applications such as mobile phones, Wi-Fi, TV, or DAB (Digital Audio Broadcasting). Since antennas also have good performance in the FM band, they can also be used for car radio.

In one embodiment, a monopole antenna includes an FM band pre-determiner able to determine the resonant frequency of the FM band and/or the bandwidth of the FM band in advance.

Such a pre-determiner make it possible to adjust the resonant frequency and/or bandwidth of the FM band when manufacturing the monopole antenna. This pre-determiner can adapt an antenna to various geographical zones where the antenna is to be used. Since in practice the FM band may be somewhat narrow depending on the geographical zone, it is possible to prioritize antenna performance in a comparatively narrow FM band, or alternatively, to prioritize antenna performance that, although not particularly good, is sufficient across a comparatively wide FM band, depending on such geographical zones.

In another embodiment, a monopole antenna includes an FM band adjuster able to adjust the resonant frequency of the FM band and/or the bandwidth of the FM band.

Such an adjuster exclusively enable commercialization of an antenna type where the user of a monopole antenna can modify the resonant frequency and FM bandwidth. The adjuster makes it possible to use an antenna in various geographical zones with different FM bands.

According to arbitrary characteristics of a monopole antenna, a monopole antenna may include emitter having a conductive supporter, preferably planar.

The conductive supporter is demarcated by an outer edge, and the monopole antenna includes

an aperture provided in the conductive supporter and demarcated by a resonant inner edge, and

a hole provided in the conductive supporter and demarcated by an edge that joins the resonant inner edge of the aperture with the outer edge of the conductive supporter.

The resonant inner edge has a resonant perimeter. A current flowing into a monopole antenna uses this edge. By appropriately selecting a perimeter value and consequently a configuration of the resonant edge, antenna performance in the FM band can be improved. This edge may typically be circular, polygonal, or elliptical.

The aperture and the hole make it possible to obtain transmission characteristics and/or receiving characteristics similar to those of a folded antenna while keeping a monopole antenna including a planar supporter.

The pre-determiner or the adjuster in the FM bandwidth includes a capacitor that joins two facing parts of the edge of the hole.

The capacitor can extend the resonant perimeter of the monopole antenna, and consequently improve performance in the FM band.

The monopole antenna accordingly includes a monopole antenna connecter provided with a supply port joined to the edge of the hole.

A desired, predetermined antenna impedance is obtained depending on the position of the connecter. Preferably, this impedance is nearly equal to the impedance of a coaxial cable, or in other words 50Ω.

In one embodiment, the external dimensions of the supporter are preferably larger than 0.1 m², more preferably larger than 0.15 m², and more preferably larger than 0.18 m².

The external dimensions correspond to the product of the maximum vertical dimensions of the supporter.

In another embodiment, the external dimensions of the supporter are preferably smaller than 0.06 m², more preferably smaller than 0.04 m², and more preferably smaller than 0.03 m².

Particularly, there are cases where it is desirable to use a monopole antenna of comparatively compact size for reasons of external dimensions or appearance. According to a monopole antenna in accordance with the present invention, it becomes possible to use a monopole antenna with an ultra wide band, good performance in the FM band, and furthermore comparatively compact.

Furthermore, since the monopole antenna is compact, a plurality of monopole antennas can be used. Such plural antennas improve the directional diversity and spatial diversity of the combined antenna obtained as a result compared to a single antenna. With such improvements in diversity, monopole antenna performance can be increased.

It is also an object of the present invention to provide an antenna assembly comprising an element formed of a plastic material for a vehicle, and a monopole antenna attached to the element formed of the plastic material. The antenna assembly may be provided with at least one monopole antenna, and may also be provided with two or three monopole antennas.

It is also an object of the present invention to provide a vehicle including at least one monopole antenna as above or an antenna assembly as above.

### BRIEF DESCRIPTION OF DRAWINGS

A more complete understanding of the present invention can be obtained when the following detailed description, herein given as an example and not as limiting, is read with reference to the attached drawings.

FIG. 1 is a diagram illustrating a vehicle that includes an antenna in accordance with a first embodiment.

FIG. 2 is a schematic perspective view illustrating the spoiler of the vehicle in FIG. 1.

FIG. 3 is a diagram illustrating a supporter for the antenna in FIG. 1.

FIG. 4 is a diagram illustrating a vehicle that includes a plurality of antennas in accordance with a second embodiment.

FIG. 5 is a diagram illustrating one of the antennas in FIG. 4.

FIG. 6 is an enlarged view illustrating zone VI in FIG. 5.

FIG. 7 is a diagram similar to FIG. 5 regarding an antenna in accordance with a third embodiment.

FIG. 8 is a diagram similar to FIG. 6 regarding an antenna in accordance with a third embodiment.

FIG. 9 is a graph illustrating variation in performance parameters according to frequency for various types of antennas.

FIG. 10 is a graph illustrating variation in performance parameters according to frequency for various types of antennas.

FIG. 11 is a graph illustrating variation in performance parameters according to frequency for various types of antennas.

FIG. 12 is a graph illustrating variation in performance parameters according to frequency for various types of antennas.

### BEST MODE FOR CARRYING OUT THE INVENTION

In several of these drawings, orthogonal coordinates X, Y, and Z are illustrated corresponding to the conventional transverse direction, lengthwise direction, and vertical direction of a vehicle.

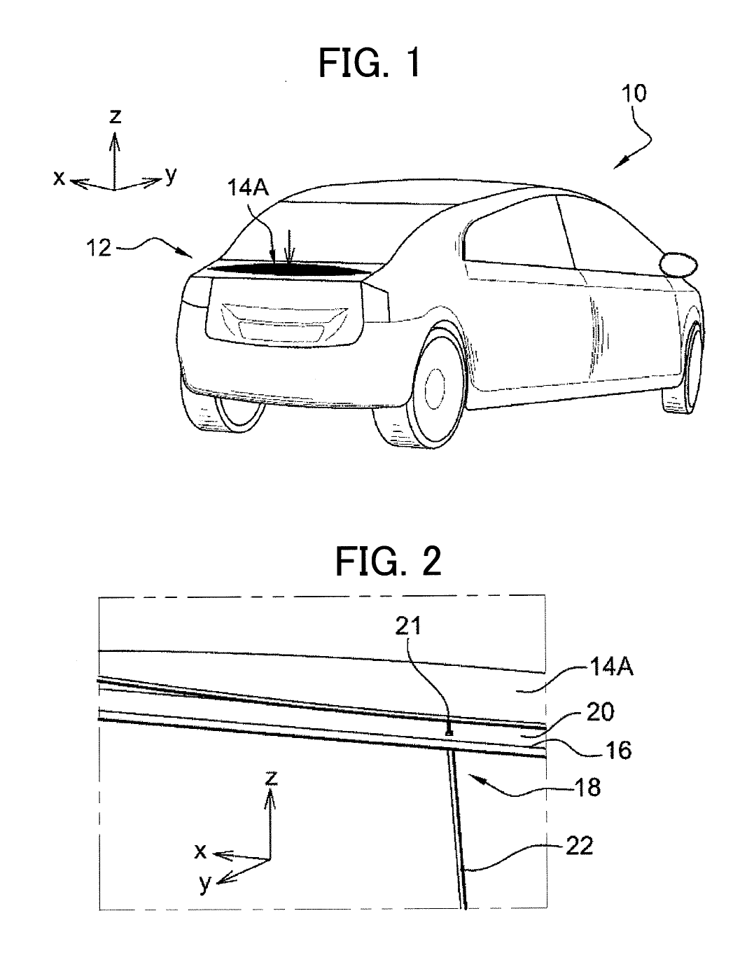

In FIG. 1, the reference sign 10 is given to indicate the automobile as a whole. The automobile includes a part 12 consisting of plastic material such as reinforced polypropylene, and including an antenna 14A. In this case, the part 12 is a spoiler or rear fin. The antenna 14A is attached to the part 12, for example, by being pasted, and is hidden below one or a plurality of coat layers. In a modified embodiment, the part 12 is the surface of the rear or front bumper, the roof, or the bonnet of the automobile.

In FIG. 2, the antenna 14A and a metal part 16 of the automobile 10 are illustrated. The antenna 14A includes a connecter 18 provided with a supply port 20 consisting of a coaxial cable 21 protected by a sheath 22. The sheath 22 is affixed to the metal part 16, while one end of the coaxial cable 21 is affixed to the antenna 14A.

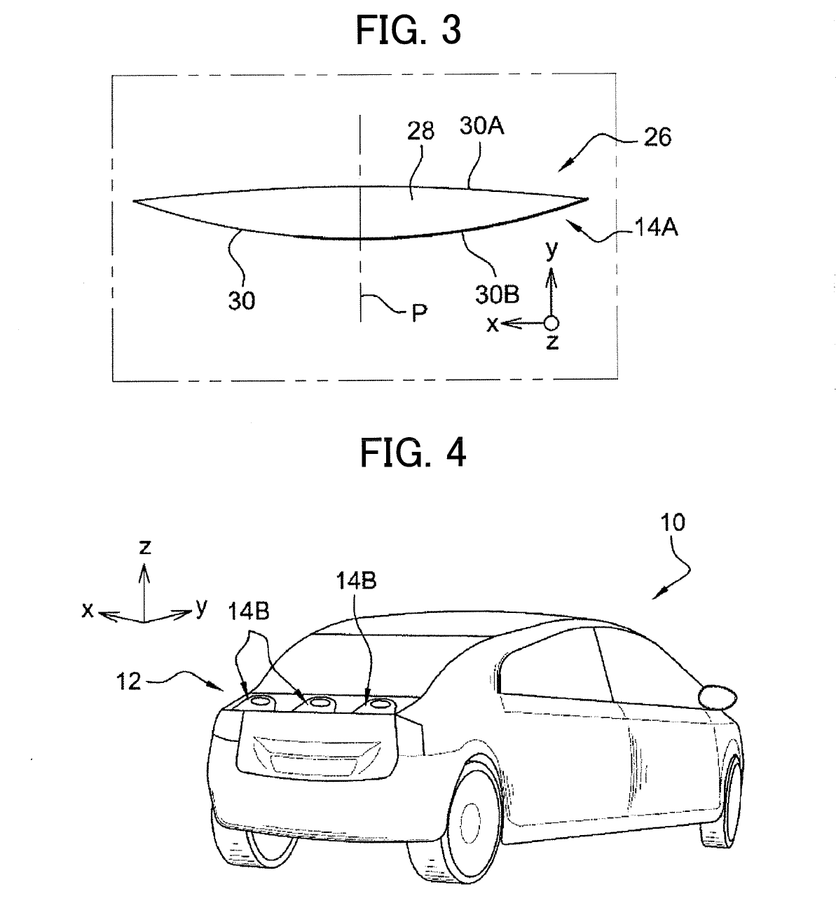

Referring to FIG. 3, the antenna 14A is an ultra wide band monopole antenna. Additionally, the antenna 14A is configured such that a frequency modulated signal can be received and/or transmitted in the predetermined frequency band that is the FM band. The antenna 14A has a reflection coefficient of less than −6 dB in a predetermined frequency band.

The antenna 14A includes an emitter 26 provided with a conductive supporter 28 composed of a conductive material such as copper, for example. The supporter 28 is a planar surface nearly parallel to the XY plane, and takes the form of an adhesive sheet. The supporter 28 is demarcated by an outer edge 30 and has a long and narrow shape overall, preferably forming a spindle elliptical shape. The outer edge 30 has two bowed parts 30A and 30B. The supporter 28 extends along the X direction. The supporter 28 is symmetrical about the center symmetry plane P parallel to the YZ plane.

The supply port 20 is affixed to the supporter 28 so as to obtain an impedance nearly equal to 50Ω.

The supporter 28 herein is 109 cm long and 17 cm wide. Consequently, its external dimensions are larger than 0.1 m², additionally larger than 0.15 m², and more accurately larger than 0.18 m², being 0.1853 m².

FIGS. 4 to 6 illustrate one or a plurality of antennas 14B in accordance with a second embodiment. Like reference signs are given to elements like those illustrated in FIGS. 1 to 3.

FIG. 4 illustrates an automobile 10 that includes three antennas 14B. The antennas 14B are arranged in a row along the transverse direction X.

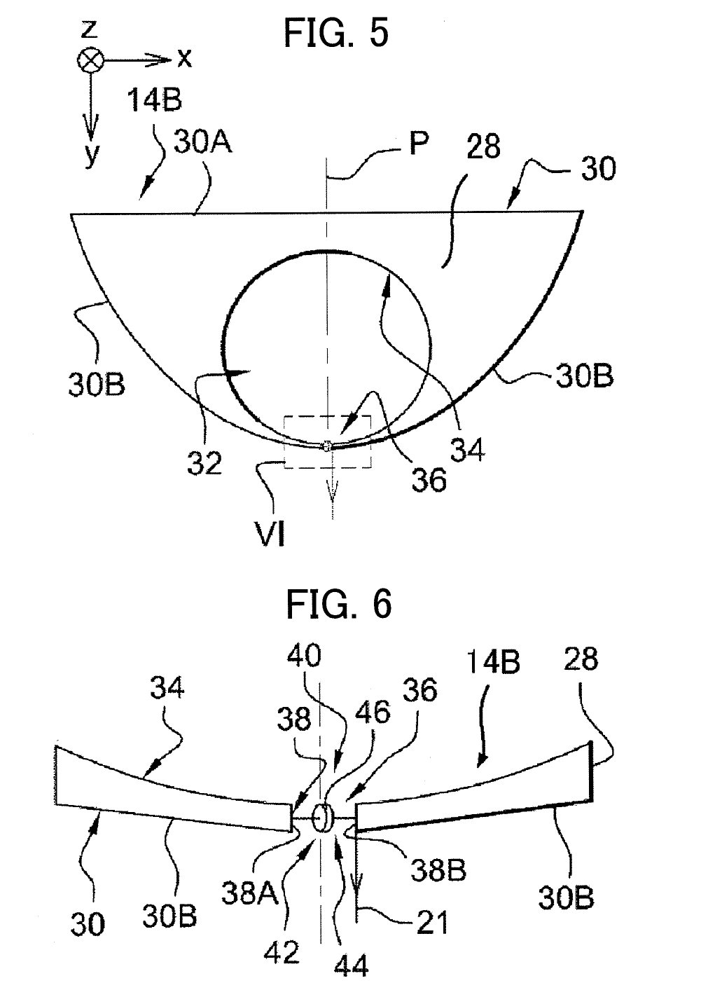

As illustrated in FIGS. 5 and 6, the supporter 28 is nearly a half-ellipse overall, and is symmetrical about the center symmetry plane P parallel to the YZ plane. The antenna 14B is provided on the supporter 28, and includes an aperture 32 demarcated by a resonant inner edge 34. Meanwhile, the antenna 14B includes a hole 36 (gap) provided in the supporter 28. The hole 36 is demarcated by an edge 38 that joins the resonant inner edge 34 and the outer edge 30. In this case, the aperture 32 is nearly circular.

The outer edge 30 has one part 30A nearly parallel to the X direction, and two bowed parts 30B. In other words, the outer edge 30 of the supporter 28 is provided with a linear part 30A configured to extend in the X direction (widthwise direction) of the vehicle, and an arced part (composed of two bowed parts 30B, 30B) configured to join one end of the linear part 30A with the other end. Additionally, the hole 36 (gap) is provided in the center of the arced part. Also, the aperture 32 is disposed at a position offset towards the arced part of the outer edge 30.

In this embodiment, the antenna 14B is inscribed in a rectangle having dimensions of 36 cm×15 cm. For this reason, the external dimensions of the supporter 28 are smaller than 0.06 m², being 0.0525 m².

The antenna 14B includes a pre-determiner 40 for the FM band. The pre-determiner 40 includes a pre-determiner 42 for a resonant frequency F₀ in the FM band on one hand, and includes a pre-determiner 44 for a bandwidth A in the FM band on the other hand. In this case, the pre-determiner 42 and 44 act mutually, and include a capacitor 46 that joins two facing parts 38A and 38B on the edge 38 of the hole 36. The supply port 20 is joined to the edge 38 which demarcates the hole 36 so as to obtain an impedance nearly equal to 50Ω.

In a modified embodiment, the antenna 14B includes frequency F₀ and bandwidth A adjuster. With this device, the user of the antenna 14B is able to modify the capacitance of the capacitor 46.

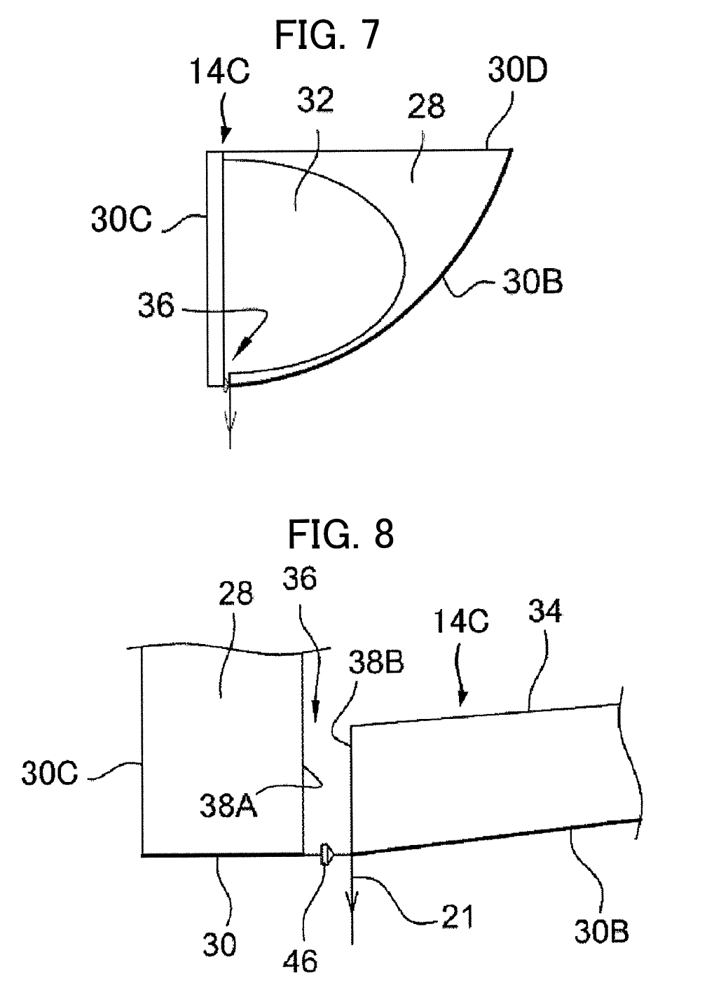

FIGS. 7 and 8 illustrate an antenna 14C in accordance with a third embodiment. Like reference signs are given to elements similar to those in the drawings illustrated hitherto.

In this embodiment, the supporter 28 takes the form of one-fourth of an ellipse overall. The antenna 14C is inscribed in a rectangle having dimensions of 19 cm×15 cm. For this reason, the external dimensions of the supporter 28 are smaller than 0.04 m², and additionally smaller than 0.03 m², being 0.0285 m². Since an antenna 14C in accordance with the third embodiment is compact, it can be hidden inside the rear-view mirror of an automobile.

The outer edge 30 includes two linear parts 30A and one bowed part 30B. In other words, the outer edge 30 of the supporter 28 is provided with a first linear part 30C, a second linear part 30D joined to the first linear part 30C and extending in a direction orthogonal to the linear part 30C, and a bowed part 30B configured to join the ends of the first linear part 30C and the second linear part 30D that are not joined together. Additionally, a hole (gap) 36 is provided at the part where the linear part 30C and the bowed part 30B intersect near the short axis of the supporter 28. The hole 36 is demarcated by edges 38A and 38B that join the resonant inner edge 34 and the outer edges 30C and 30B.

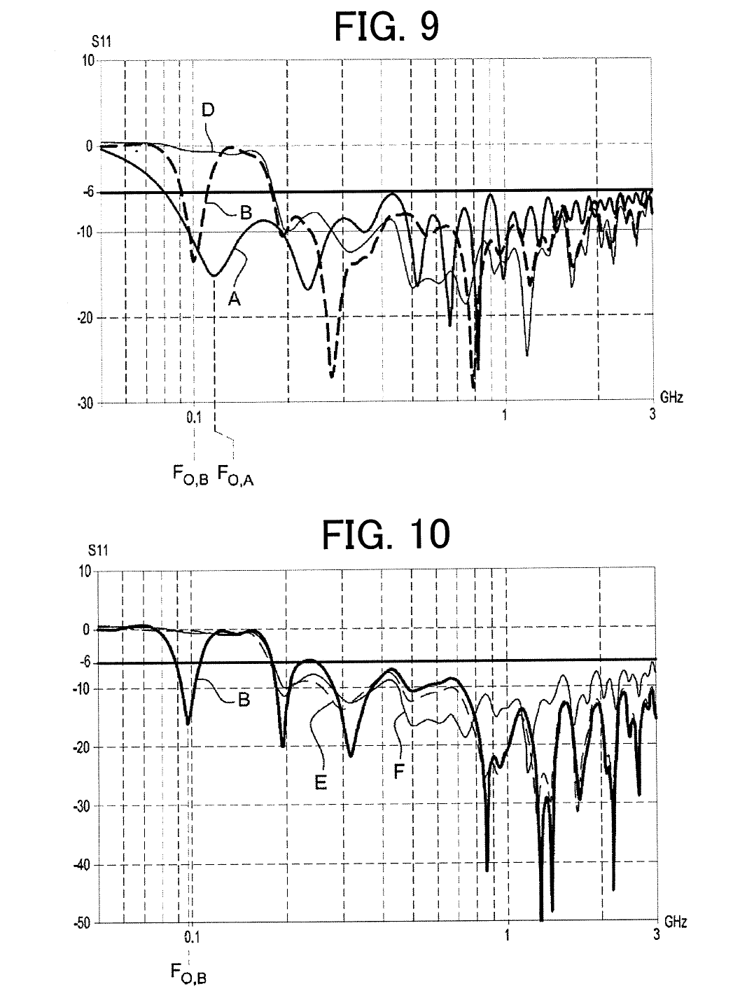

FIG. 9 illustrates variation in the S11 parameter according to frequency (logarithmic scale) for an antenna 14A in accordance with the first embodiment (curve A, bold solid line), an antenna 14B in accordance with the second embodiment (curve B, bold broken line), and an ultra wide band antenna in accordance with the related art (curve D, regular line).

The parameter S11 for an antenna in accordance with the related art is nearly zero from 50 MHz to 170 MHz, and less than −6 dB from 180 MHz. For this reason, an antenna in accordance with the related art has good performance in the high frequency band past 180 MHz. However, the FM frequency band is not included in this band.

The parameter S11 for the antenna 14A is less than −6 dB from 80 MHz, and has the FM band with a resonant frequency f_{0,A} at nearly 110 MHz. For this reason, the antenna 14A has good performance in the frequency band from 80 MHz to 3 GHz. Consequently, the antenna 14A has an ultra wide band, and particularly covers the FM frequency band.

The parameter S11 of the antenna 14B is less than −6 dB in a first range from approximately 88 MHz to 110 MHz, and subsequently in a second range from approximately 170 MHz to 3 GHz. The parameter S11 has the FM band with a resonant frequency F_{0,B} at nearly 100 MHz in the first range. Consequently, the antenna 14B has an ultra wide band, and particularly covers the FM frequency band.

The parameter S11 of the antennas 14A and 14B is less than −6 dB in a frequency range from 190 MHz to 3 GHz.

FIG. 10 illustrates variation in the parameter S11 for an antenna 14B of the type in the second embodiment (curve B, bold solid line), an antenna 14B of the type in the second embodiment without an aperture 32 (curve E, regular broken line), and an antenna 14B of the type in the second embodiment without an aperture 32 nor a hole 36 (curve F, regular line).

The external dimensions of the supporter 28 for the antennas 14B whose parameter S11 is illustrated in FIG. 10 is smaller than 0.06 m².

In the case of no aperture 32 and no hole 36, the FM frequency band cannot be covered. Similarly, in the case of no hole 36, FM frequency band coverage is insufficient despite the presence of an aperture 32. Consequently, when the external dimensions are a given value, in this case smaller than 0.06 m², the presence of an aperture 32 and a hole 36 are necessary in order for the antenna 14B to have high performance in a predetermined FM frequency band. The parameter S11 of the antennas 14B illustrated in FIG. 10 has a band with a resonant frequency F_{0,B} nearly equal to 95 MHz.

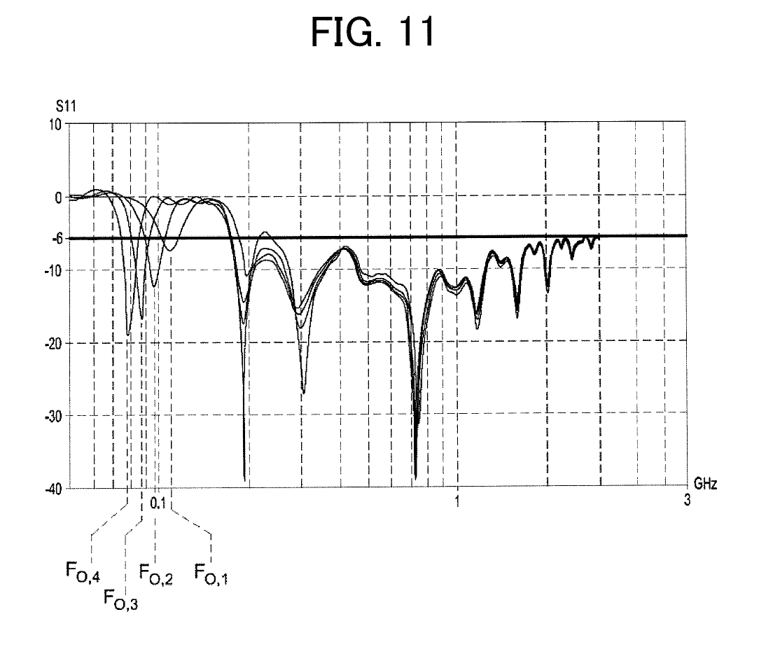

FIG. 11 illustrates variation in the antenna parameter S11 with respect to various values for the capacitance C of the capacitor 46.

Each antenna has a parameter S11 having one band in an FM frequency range from approximately 70 MHz to 100 MHz. Each band in this range has a resonant frequency F₀ corresponding to the value for the capacitance C of the capacitor. The resonant frequency F₀ decreases as the value for the capacitance C increases. In the case of the capacitances 4·10⁻¹² F, 7·10⁻¹² F, 1·10⁻¹¹ F, and 1.3·10⁻¹¹ F, the frequencies F_{0,1}, F_{0,2}, F_{0,3}, and F_{0,4} are nearly equal to 105 MHz, 98 MHz, 89 MHz, and 79 MHz, respectively. Consequently, the capacitor 46 can determine in advance and/or adjust the frequency F₀ of the band that covers FM band frequencies.

Furthermore, the bandwidth A decreases as the value for the capacitance C increases. For this reason, the capacitor 46 can determine in advance and/or adjust the bandwidth F₀ of the band that covers FM band frequencies.

Varying the capacitance C of the capacitor 46 effects little to no change in the resonant frequencies of other bands covering frequency ranges greater than 150 MHz.

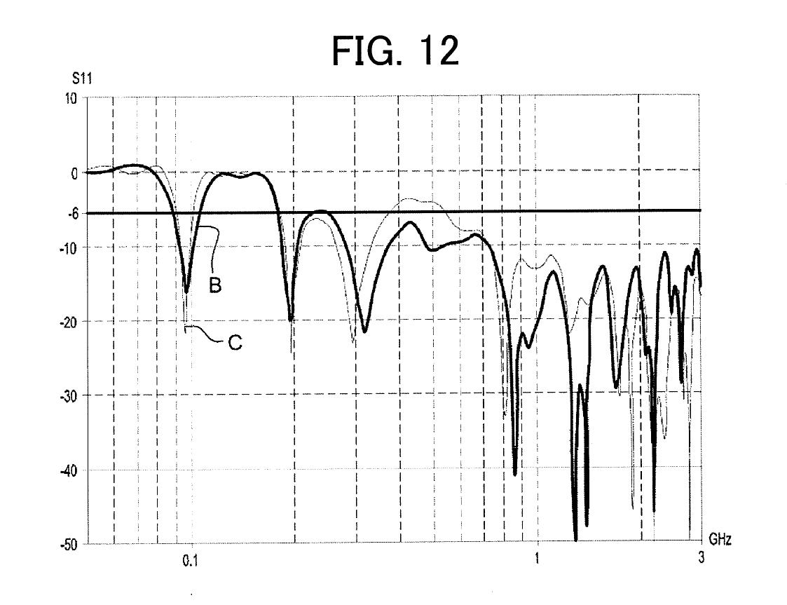

FIG. 12 illustrates variation in the parameter S11 for an antenna 14B in accordance with the second embodiment (curve B, bold solid line) and an antenna 14C in accordance with the third embodiment (curve C, regular line).

As similarly illustrated in FIGS. 9 and 10, the parameter S11 of the antenna 14B is less than −6 dB in a first frequency range from approximately 88 MHz to 110 MHz, and subsequently in a second frequency range from approximately 170 MHz to 3 GHz. Consequently, the antenna 14B has an ultra wide band, particularly covers the FM frequency band, and has good performance in this band.

The external dimensions of the supporter 28 for the antenna 14C are smaller than 0.03 m². The parameter S11 of the antenna 14C is less than −6 dB in a first frequency range from approximately 87 MHz to 110 MHz, subsequently in a second frequency range from approximately 170 MHz to 360 MHz, and furthermore in a third frequency range from approximately 560 MHz to 3 GHz. Consequently, the antenna 14C has an ultra wide band, particularly covers the FM frequency band, and has good performance in this band.

The electromagnetic spectrum includes a plurality of frequency bands dedicated to various applications. These dedicated frequency bands vary significantly by geographical zone. As an example, the frequency bands used for FM radio, DAB (Digital Audio Broadcasting), TV, inter-vehicular communication, Wi-Fi, and mobile phones in Europe, the United States, and Japan are indicated in Table 1.

TABLE 1

| Application | Europe (MHz) | USA (MHz) | Japan (MHz) |
|---|---|---|---|
| FM radio | 88~108 | 88~106 | 70~90 |
| DAB | 174~237 | 88~106 | 470~770 |
| TV | 175~862 | 175~806 | 170~770 |
| Inter-vehicle comm. | 5900 | 5900 | 700 |
| Wi-Fi | 2400~5800 | 2400~5800 | 2400~5800 |
| Mobile phones | 900~1800 | 700~2170 | 810~2170 |

Each of the antennas 14A, 14B, and 14C can be used in various geographical zones depending on the application which is desired to be made useable. With the frequency F₀ and bandwidth A pre-determiner 42 and 44, the FM frequency band can be adapted to a geographical zone.

The following Table 2 (antenna of a type in accordance with the second embodiment) and Table 3 (antenna of a type in accordance with the third embodiment) indicate the external dimensions, value for capacitance C, and ranges where the parameter S11 is equal to or less than −6 dB, or in other words ranges where antenna performance is good, for the respective geographical zones of Europe, the United States, and Japan.

TABLE 2

| | Europe | USA | Japan |
|---|---|---|---|
| Ext. dimensions | 0.0525 | 0.0525 | 0.0525 |
| (m²) | | | |
| Capacitance (pF) | 60 | 60 | 87 |
| Ultra wide band | 170 MHz~6 | 170 MHz~6 GHz | 170 MHz~6 GHz |
| range where S11 < | GHz | | |
| −6 dB | | | |
| FM band range | 85 MHz~110 | 85 MHz~110 | 69 MHz~90 MHz |
| where S11 < −6 dB | MHz | MHz | |

TABLE 3

| | Europe | USA | Japan |
|---|---|---|---|
| Ext. dimensions | 0.0285 | 0.0285 | 0.0285 |
| (m²) | | | |
| Capacitance (pF) | 7.5 | 7.5 | 11 |
| Ultra wide band | 170 MHz~360 | 170 MHz~360 | 170 MHz~360 |
| range where S11 < | MHz | MHz | MHz |
| −6 dB | 560 MHz~6 | 560 MHz~6 | 560 MHz~6 GHz |
| | GHz | GHz | |
| FM band range | 87 MHz~108 | 87 MHz~108 | 73 MHz~88 |
| where S11 < −6 dB | MHz | MHz | MHz |

The present application is based on French Patent Application No. 0952472 filed on Apr. 15, 2009, the specification, claims, and drawings of which are herein incorporated in their entirety by way of reference.

1-12. (canceled)

13. A monopole antenna having an ultra wide band, and configured to be able to receive and/or transmit at least a frequency-modulated signal in an FM band, which is a predetermined frequency band where the reflection coefficient S11 is less than −6 dB,
the monopole antenna further including an emitter having a planar, conductive supporter,
wherein the conductive supporter is demarcated by an outer edge, and the monopole antenna includes
an aperture provided in the conductive supporter and demarcated by a resonant inner edge, and
a hole provided in the conductive supporter and demarcated by an edge that joins the resonant inner edge of the aperture with the outer edge of the conductive supporter.

14. The monopole antenna according to claim 13, wherein the ultra wide band has a bandwidth greater than a minimum value among values equal to 20% of the center frequency of the band, or greater than 500 MHz.

15. The monopole antenna according to claim 13, including an FM band pre-determiner able to determine the resonant frequency of the FM band and/or the bandwidth of the FM band in advance.

16. The monopole antenna according to claim 13, including an FM band adjuster able to adjust the resonant frequency of the FM band and/or the bandwidth of the FM band.

17. The monopole antenna according to claim 15, wherein the FM band pre-determiner includes a capacitor that joins two facing parts of the edge of the hole.

18. The monopole antenna according to claim 16, wherein the FM band adjuster includes a capacitor that joins two facing parts of the edge of the hole.

19. The monopole antenna according to claim 13, including a monopole antenna connecter provided with a supply port joined to the edge of the hole.

20. The monopole antenna according to claim 13, wherein the external dimensions of the conductive supporter are larger than 0.1 m2.

21. The monopole antenna according to claim 13, wherein the external dimensions of the conductive supporter are smaller than 0.06 m2.

22. An antenna assembly comprising an element formed of a plastic material for a vehicle, and a monopole antenna according to claim 13 attached to the element formed of the plastic material.

23. A vehicle including at least one monopole antenna according to claim 13.
